(19) United States
(12) Patent Application Publication
(10) Pub. No.: US 2019/0114622 A1
(43) Pub. Date: Apr. 18, 2019

(54) SYSTEM FOR EXECUTING A REAL-TIME ON-LINE RATING OF A PLURALITY OF CREDIT CARDS

(71) Applicant: WEYMEDIA INC., Moncton (CA)

(72) Inventors: STEPHEN WEYMAN, MONCTON (CA); MARIA WEYMAN, MONCTON (CA)

(21) Appl. No.: 16/027,302

(22) Filed: Jul. 4, 2018

Related U.S. Application Data
(60) Provisional application No. 62/571,485, filed on Oct. 12, 2017.

(51) Int. Cl. G06Q 20/34; G06Q 40/02; G06Q 30/02

(52) U.S. Cl. CPC G06Q 20/355; G06Q 30/0226; G06Q 40/025

(57) ABSTRACT

A system and method for executing a real-time online rating of credit cards is disclosed. A communication network interconnects a rating system with user devices each comprising a user interface comprising a first input comprising a plurality of sliders each corresponding to a respective pair of benefits. Each outer position is associated with the user's preference for one of the pair of benefits and the middle position is associated with a user preference for neither of the respective pair of benefits. Other inputs are also provided such as a typical monthly spending. The user device transmits input data to a rating system via the network. The system stores a plurality of card data sets and uses weighting instructions to combine weighting coefficients and the card data sets with inputs to generate a set of ranked credit cards, and transmits the set of ranked cards to the user via the network.

### CROSS REFERENCE TO RELATED APPLICATIONS

This application is claims priority to U.S. Provisional Application No. 62/571,485, filed Oct. 12, 2017. The entire contents of the foregoing Provisional Application is hereby incorporated by reference.

### FIELD OF THE INVENTION

The present invention relates to a system for executing a real-time online rating of a plurality of credit cards.

### BACKGROUND OF THE INVENTION

The prior art discloses systems and methods which rate or rank credit cards based on user input using one of two approaches, either net annual rewards a holder is theoretically able to achieve, or an editorial rating system based on the knowledge of the reviewer. One drawback of these approaches is that they fail to take into account other attributes such as insurance coverage, interest rates and a plethora of other common or unique advantages that each card offers. Another drawback is that the rating systems and methods are typically inconsistent, periodically taking into account only one or other of the rewards or attributes.

What is needed therefore, and an object of the present, is an evaluation system and method for rating credit cards which operates in real time and holistically.

### SUMMARY OF THE INVENTION

In order to address the above and other drawbacks there is provided a computer system for executing a real-time online rating of a plurality of credit cards. The system comprises a communication network interconnecting an online rating system with at least one user device, the at least one user device comprising a display and at least one user device processor and operatively associated user device electronic storage, wherein the user device storage comprises user device instructions that, when executed by the at least one user device processor, cause the at least one user device: to provide a user interface via the display, the user interface comprising: a first input comprising a plurality of sliders, each of the sliders corresponding to a respective pair of benefits and comprising a slider thumb slideable between at least a first position and a second position and a third position in between the first position and the second position, wherein the first position is associated with the user's preference for a first one of the respective pair of benefits, the second position is associated with the user's preference for a second one of the respective pair of the benefits and the third position is associated with a user preference for neither of the respective pair of benefits, a second input corresponding to a typical monthly spending amount of the user, and a ranked list of credit cards, receive from the user, via the user interface, as input data the first and second inputs, transmit the input data to the rating system via the communication network, receive from the rating system via the communication network the ranked list of credit cards in response to providing the input data, the online rating system comprising: a database storing a plurality of card data sets, each of the card data sets corresponding to a respective one of the plurality of credit cards, each of the card data sets comprising a plurality of associated rewards and each of a plurality of associated features, and a weighting engine comprising at least one weighting processor and operatively associated weighting electronic storage, wherein the weighting storage comprises benefit weighting coefficients and weighting instructions that, when executed by the at least one weighting processor, cause the weighting engine to, in response to reception of the input data from the at least one user device, retrieve a plurality of the card data sets from the database, calculate a plurality of different benefit ranks using the plurality of associated rewards and the plurality of associated features for each of the card data sets wherein at least one of the different benefit ranks is calculated using additionally the second input, and combine the calculated benefit ranks according to the benefit weighting coefficients and according to the first input data to generate a set of ranked credit cards, and transmit the set of ranked credit cards to the user device as the ranked list of credit cards.

There is also provided a method for executing a real-time online rating of a plurality of credit cards for a user. The method comprises interconnecting using a communication network an online rating system with a user device associated with the user, the user device comprising a display screen, displaying on the display screen: a first input comprising a plurality of sliders, each of the sliders corresponding to a respective pair of benefits and comprising a slider thumb slideable between at least a first position and a second position and a third position in between the first position and the second position, wherein the first position is associated with the user's preference for a first one of the respective pair of benefits, the second position is associated with the user's preference for a second one of the respective pair of the benefits and the third position is associated with a user preference for neither of the respective pair of benefits, a second input corresponding to a typical monthly spending amount of the user, and a ranked list of credit cards, the user device: receiving from the user, via the user interface, as input data the first and second inputs, transmitting the input data to the online rating system via the communication network, receiving from the online rating system via the communication network the ranked list of credit cards in response to providing the input data, and displaying the ranked list of credit cards on the display screen as the ranked list of credit cards, in response to reception of the input data from the user device, the online rating system: retrieving a plurality of card data sets from a database, each of the card data sets corresponding to a respective one of the plurality of credit cards, each of the card data sets comprising a plurality of associated rewards and a plurality of associated features, retrieving a plurality of card data sets from a database, each of the card data sets corresponding to a respective one of the plurality of credit cards, each of the card data sets comprising a plurality of associated rewards and a plurality of associated features, calculating a plurality of different benefit ranks using the plurality of associated rewards and the plurality of associated features for each of the card data sets wherein at least one of the different benefit ranks is calculated using additionally the second input, combining the calculated benefit ranks according to at least one benefit weighting coefficient and the first input data to generate a set of ranked credit cards, and, and transmitting the set of ranked credit cards to the user device as the ranked list of credit cards.

### BRIEF DESCRIPTION OF THE DRAWINGS

FIG. 1 provides a schematic diagram of an online credit card evaluation system in accordance with an illustrative embodiment of the present invention;

FIG. 2 provides a schematic diagram of an online credit card rating system in accordance with an illustrative embodiment of the present invention;

FIGS. 3A through 3G provide user input and output display screens as rendered on a client smartphone device in accordance with an illustrative embodiment of the present invention;

FIG. 4 provides a user input and output display screen as rendered on a client personal computing device in accordance with an illustrative embodiment of the present invention;

FIG. 5A provides a flow chart of a credit card rating system in accordance with an illustrative embodiment of the present invention;

FIG. 5B provides a schematic diagram of a reward rank generation system in accordance with an illustrative embodiment of the present invention;

FIG. 5C provides a schematic diagram of an insurance rank generation system in accordance with an illustrative embodiment of the present invention;

FIG. 5D provides a schematic diagram of a fee rank generation system in accordance with an illustrative embodiment of the present invention;

FIG. 5E provides a schematic diagram of an interest rank generation system in accordance with an illustrative embodiment of the present invention;

FIG. 5F provides a schematic diagram of a perks rank generation system in accordance with an illustrative embodiment of the present invention;

FIG. 5G provides a schematic diagram of an approval rank generation system in accordance with an illustrative embodiment of the present invention;

FIG. 5H provides a schematic diagram of an acceptance rank generation system in accordance with an illustrative embodiment of the present invention; and

FIG. 5I provides a schematic diagram of a review rank generation system in accordance with an illustrative embodiment of the present invention.

### DETAILED DESCRIPTION OF THE ILLUSTRATIVE EMBODIMENTS

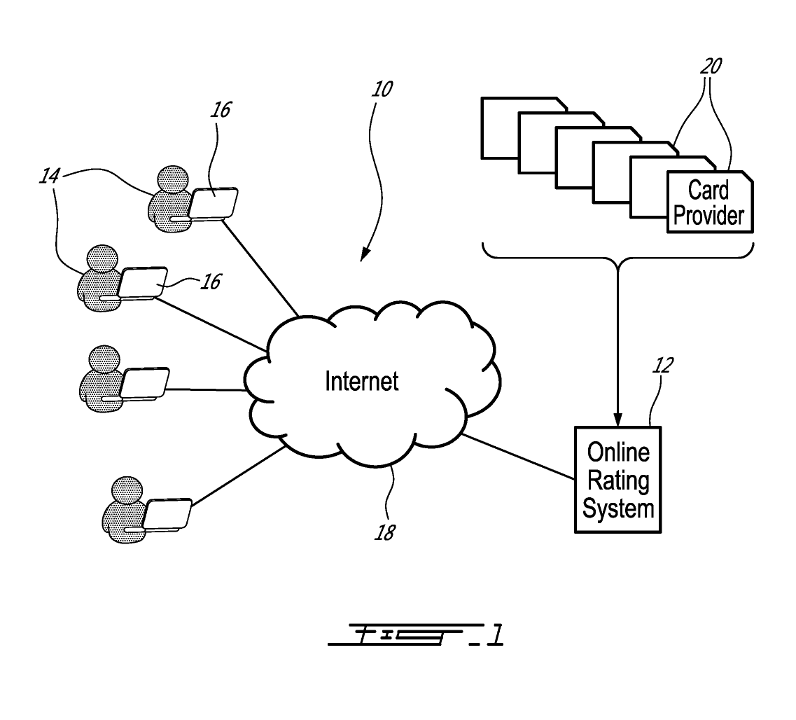

Referring now to FIG. 1, a system for executing a real-time online rating of a plurality of credit cards, generally referred to using the reference numeral 10, will now be described. The system 10 comprises an online rating system 12 interconnected with a plurality of users 14 and their associated devices 16 via a wide area network (WAN) such as the Internet 18. The users 14 are provided by the online rating system 12 with a real-time evaluation of a plurality of credit cards (not shown) available from a plurality of credit card issuers 20.

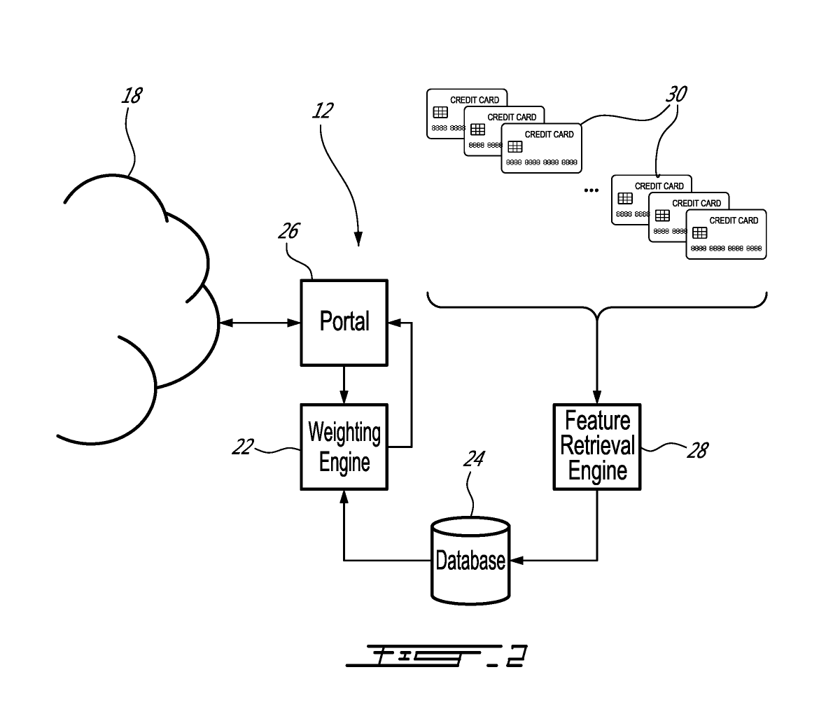

Referring now to FIG. 2 in addition to FIG. 1, the online rating system 12 comprises a weighting engine 22, associated database 24 and portal 26, such as a website or the like, which is accessible using a user device 16 via the WAN 18, for example using a domain name or IP address. A benefit retrieval engine 28 retrieves card benefits, such as rewards and features and the like, of a large plurality of credit cards 30 issued by the plurality of card issuers 20. The benefit retrieval engine 28 may, for example, scrape card issuer websites and the like (not shown) to retrieve card benefits or may include data entered manually, for example following analysis of a card issuers terms and conditions or the like. As will be discussed in more detail below, users 14 wishing to evaluate in real-time the plurality of credit cards 30 based on their respective card benefits may access the online rating system 12 via the portal 26 using their user device 16 and via the wide area network 20.

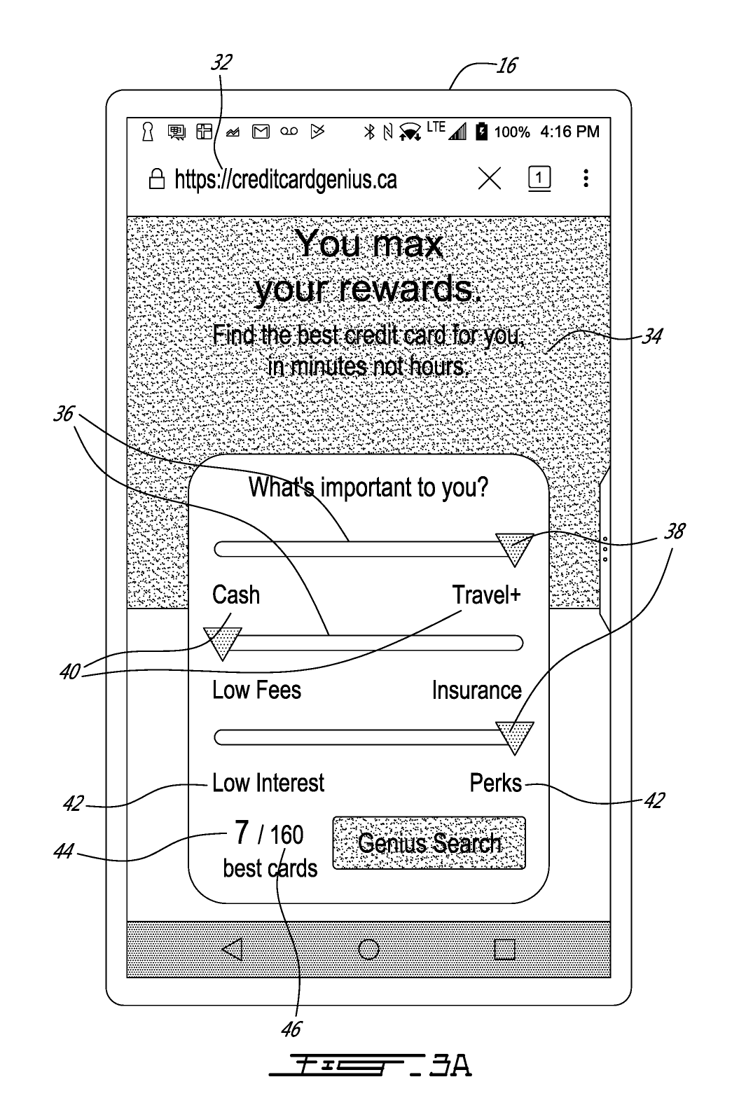

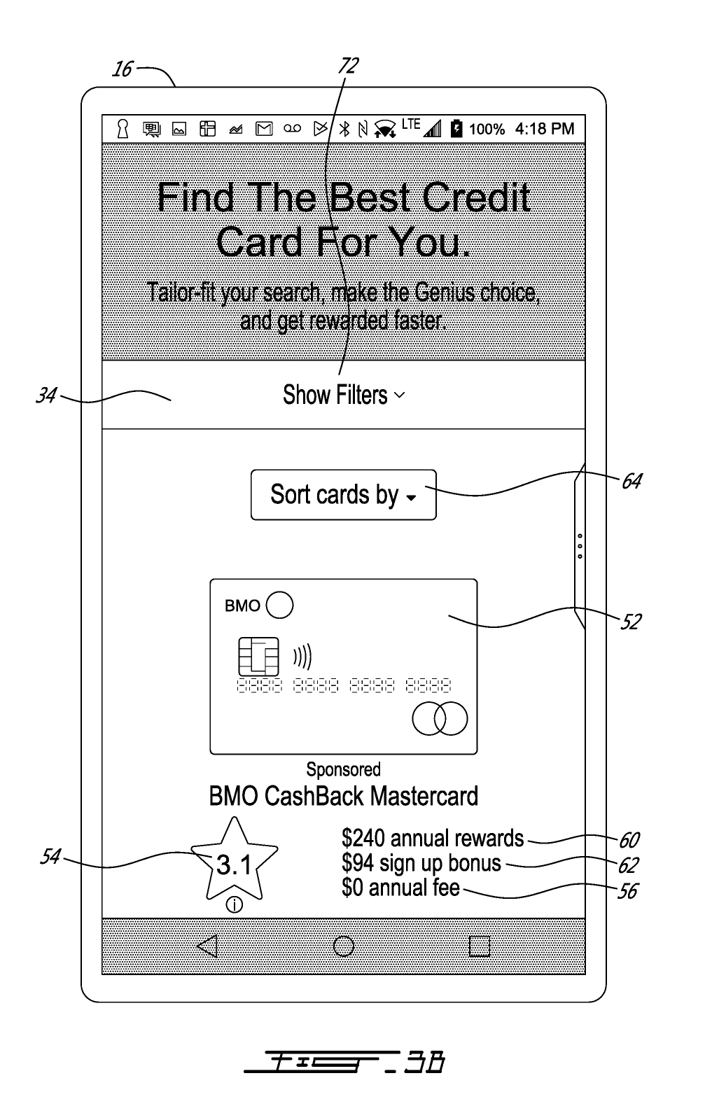

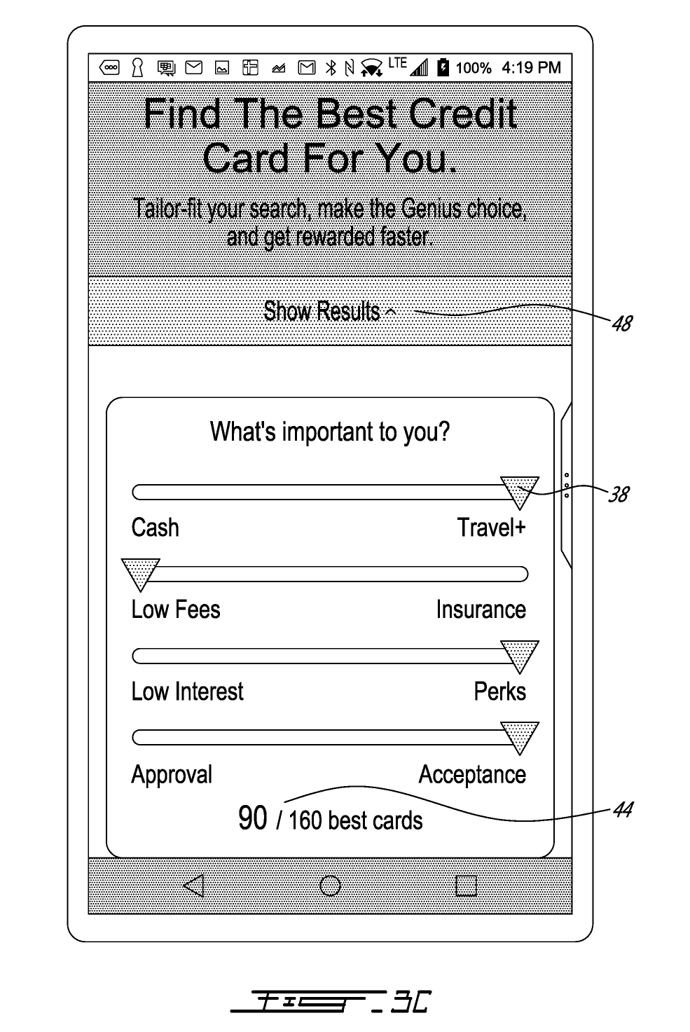

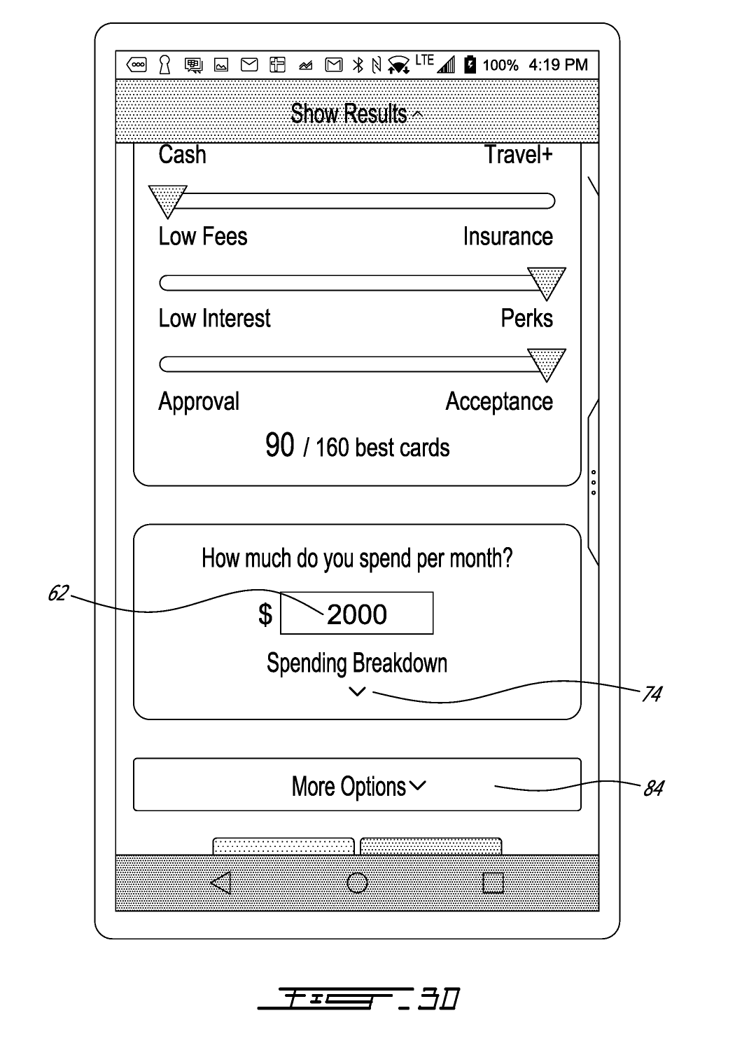

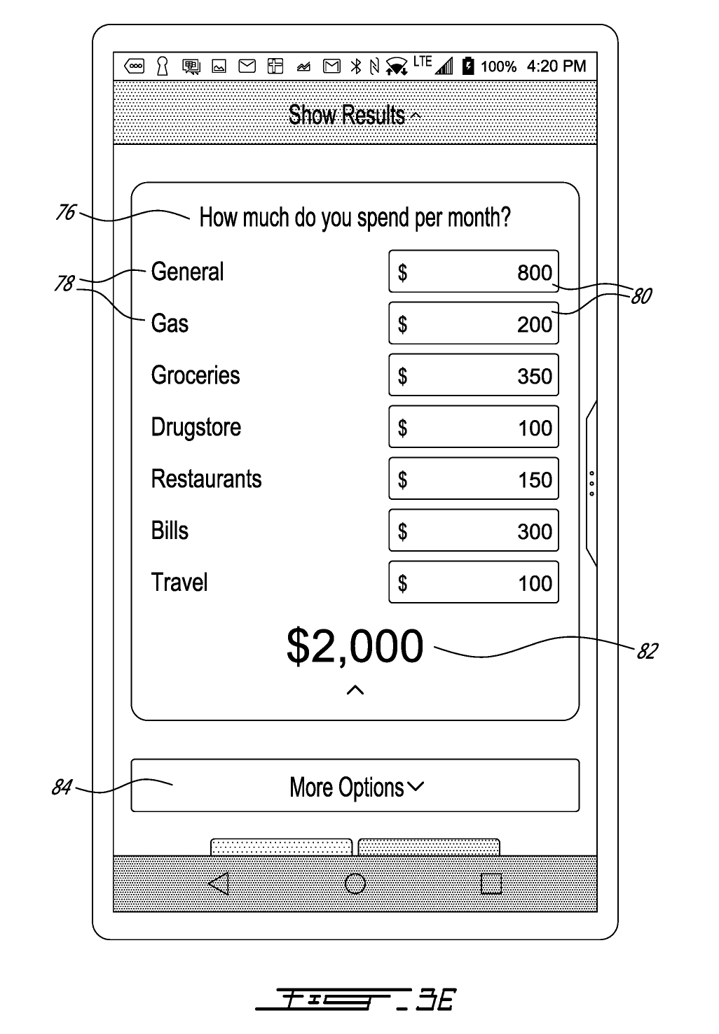

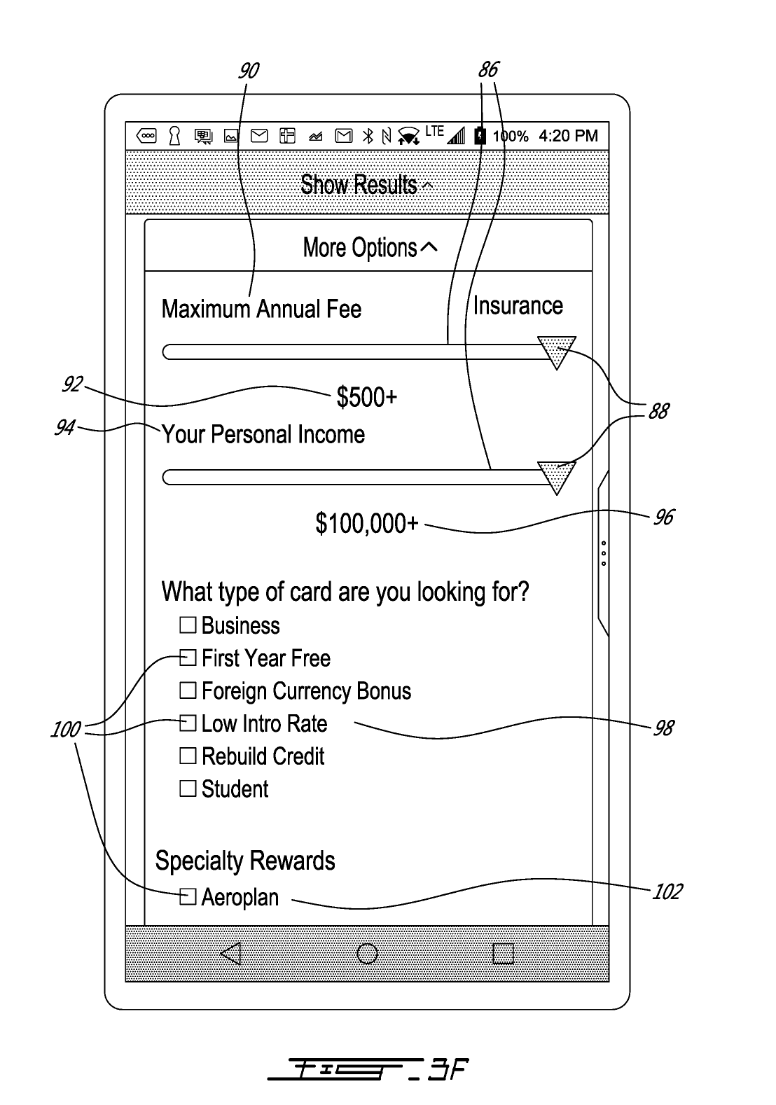

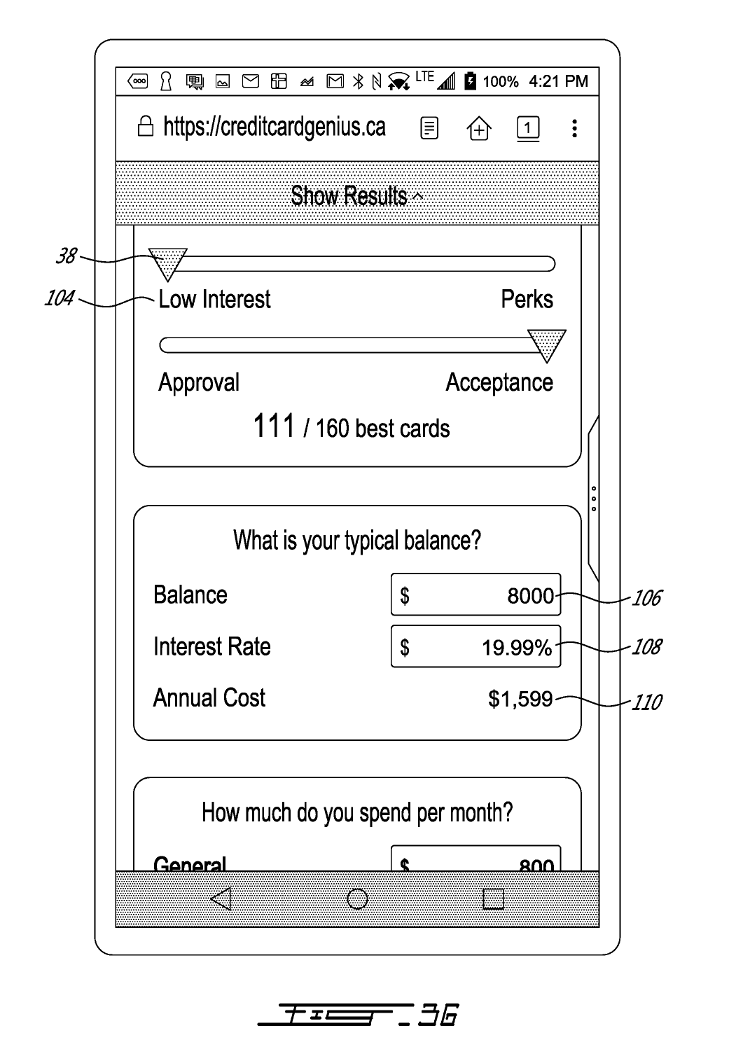

Referring now to FIG. 3A in addition to FIG. 1, each user device 16, such as Smartphone, personal computer, tablet or the like, is illustratively equipped with a web browser application software 32 for displaying a web page 34 received at the web browser application software 32 in response to accessing the portal 26 via the WAN 18. Alternatively, the user device 16 could run a customized client application (not shown) for interacting with the portal 26 via the WAN 18. The web page 34 description includes code in a format such as HTML which populates the screen with a variety of information and control elements. In particular, the user 14 is presented via the web page 34 with a first input comprising a plurality of sliders 36 which each allow the user to select between different preferred benefits by positioning the slider thumb 38 adjacent one or other of the listed rewards 40, for example cash back or travel and associated rewards such as points or the like, or of the different preferred features 42, such as low interest rate or perks (which includes such perks as warranty coverage, lounge access or the like). In a particular embodiment, and in the event a user is undecided about whether one or other of the presented rewards or features is preferred, the slider thumb 38 may be positioned in between the two listed rewards 40 or features 42.

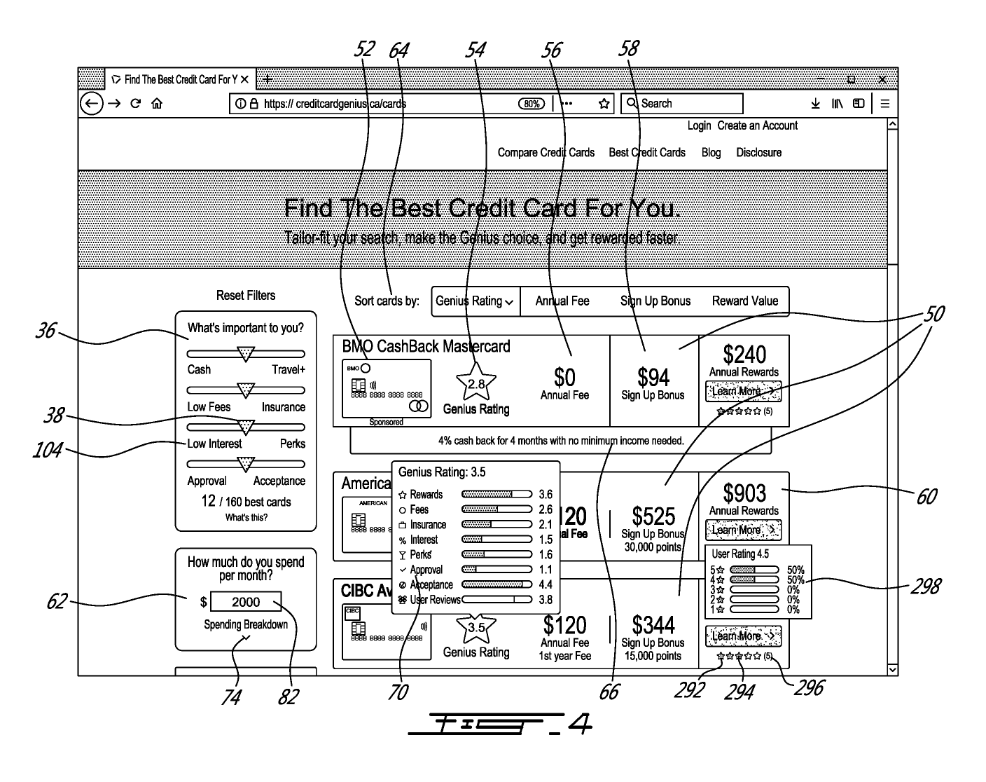

Referring back to FIG. 2 in addition to FIG. 3A, the preference between pairs of benefits indicated by the user by the slider thumb 38 movement is transmitted to the rating system 12 via the WAN 18 as input data which is used by the weighting engine 22 in part to generate a subset of ranked credit cards selected in accordance with the user preference and transmit the subset of ranked credit cards to the user device 16 for immediate display as the ranked list of credit cards. In an illustrative embodiment, each benefit is provided with a default weighting which is used, for example, when none of the benefits are indicating as being preferred (i.e. when all the slider thumbs 38 are positioned between benefits). In a particular embodiment, moving a slider thumb 38 to indicate the preference of a particular benefit increases the relative weighting of that preferred benefit over all other benefits and such that the preferred benefit has a greater influence on the overall card ranking. In an alternative embodiment selection of a preferred benefit has the effect of removing the unselected benefit when calculating the overall ranking, which is the same as setting that unselected benefit's weighting to 0. The user is provided with the number of cards 44 which make up the ranked list as well as the total number of cards 46. Referring to FIG. 3C in addition to FIG. 3B, on movement of one or other of the slider thumbs 38 to a new position, the slider thumb 38 movement is transmitted in real time to the rating system 12 via the WAN 18 as input data which is again used by the weighting engine 22 to generate in real time an updated subset of ranked credit cards selected in accordance with the new user preferences. The updated subset of ranked credit cards is returned to the user device 16 for display in real time as an updated ranked list of credit cards. Depending on the capabilities of the user device 16, such as screen size and resolution, the user may be prompted to select a control 48 to display the ranked list. In an alternative embodiment, for example on a personal computer or the like, and with reference to FIG. 4, the subset of ranked credit cards 50 may be displayed adjacent the sliders 36 and as will be discussed in more detail below, other input fields. Alternatively, the ranked list may be displayed by simply scrolling lower.

Referring now to FIG. 3B and FIG. 4, each ranked card 50 in the ranked list is displayed together with a card image 52, a card ranking 54 (illustratively a value between 0 and 5) as well as other fields such as the annual fee 56 and annual bonus 58. Additionally, and as will be described in more detail below, a projected reward value 60 for each ranked card is also displayed, generated by the weighting engine 22 according to the user's indicated monthly spending profile 62, which will be discussed in more detail below. With reference back to FIG. 1, in a particular embodiment the monthly spending profile 62 can be automatically retrieved from the Card Provider 20 or the user's bank (not shown) for example by downloading the user's transaction history or the like. Ranked cards 50 may be sorted in either ascending or descending order and according to their rank, annual fee, sign up bonus and reward value via a sort control 64. Additional interesting information vis-a-vis one or other can be displayed in a bonus feature display field 66. If a user wishes to learn specific details about one or other of the ranked cards, this can be displayed by selecting the “learn more” control button 68. Additional information 70 regarding a breakdown of the rating can be viewed by rolling over a respective one of the card ranking 54 icons. In this regard, benefits may be presented clearly or shaded to reflect their influence on the current overall card ranking (with the exception of users reviews which are illustratively presented shaded until a minimum trust factor, as will be discussed below, has been attained). Referring back to FIG. 3B, in a smaller format device the various benefits selected by the user can be quickly displayed by selecting the display filters control 72.

Referring now to FIG. 3D in addition to FIG. 3C, by scrolling downwards, or with reference to FIG. 4, a second input comprising a spending profile 62 can be modified. A single amount may be entered, or, with reference to FIG. 3E, by selecting the spending breakdown control 74, a spending breakdown 76 can be revealed comprising a plurality of different spending categories 78 and their associated second input fields 80. By default, the second input fields 80 are illustratively filled with amounts which represent a percentage of their total monthly spending amount 82. Spending categories 78 represent categories for which rewards are typically issued. An example list of spending categories 78 and their relative default purchasing percentages comprises:

| | |
|---|---|
| General | 40% |
| Gas (i.e. fuel for automobiles) | 10% |
| Groceries | 17.5% |
| Drugstore | 5% |
| Restaurants | 7.5% |
| Bills | 15% |
| Travel | 5% |
| Total | 100% |

The above default percentages are considered non-limiting. The user can modify the relative amounts by modifying the dollar amounts in one or other of the second input fields 80. Modification of one or other amounts via the second input fields results in an adjusted total monthly spending amount 82 and is transmitted without other user input to the rating system 12 via the WAN 18. The rating system 12 responds with an updated list of ranked cards 50.

Referring to FIG. 3F in addition to FIG. 3D, FIG. 3E and FIG. 4, selection of the more options control 84 reveals a pair of inputs each comprising a slider control 86 and a slider thumb 88. A first of the controls 90 is illustratively used for entering a maximum annual fee 92 for a card which would be tolerated by the user. A second of the controls 94 is illustratively used to enter a yearly income 96 of the user. In a first embodiment movement of one or other of the slider thumbs 88 results in an increase or decrease of the respective input which is used to filter out any ranked cards 50 which do not meet the criteria input by the slider thumbs 88 without altering scores. In a second embodiment, movement of one or other of the slider thumbs 88 results in an increase or decrease of the respective input which is transmitted without additional user input to the rating system 12 via the WAN 18 which responds with a list of ranked cards 50 with updated scores.

Still referring to FIG. 3F, additional user/card preferences 98, such as business, first year free, foreign currency bonus, low introduction rate, rebuild credit and student can be selected via one of a plurality of check boxes 100. A user may also select one of a plurality of different speciality rewards 102, such as Aeroplan or Air Miles or the like, via one of a plurality of check boxes 100. Preferences and specialty rewards selected using of one or other of the check boxes 100 is transmitted without additional user input to the rating system 12 via the WAN 18 which responds with an updated list of ranked cards 50.

Referring now to FIG. 3G in addition to FIG. 3C and FIG. 4, placing of a slider thumb 38 to indicate that a user preference is for low interest 104 prompts the user to enter a typical monthly balance 106. A default interest rate 108 based on an industry average may be used to provide the user quick feedback as to what a typical annual interest cost 110 might be. Selection of low interest 104 or modification of the typical monthly balance 108 is transmitted without additional user input to the rating system 12 via the WAN 18 which responds with an updated list of ranked cards 50.

Still referring to FIG. 3G, a slider thumb 38 may also be used to select a user preference of approval or acceptance. Selecting approval takes into account income requirement as well as the minimum credit score requirement for each card to calculate an eligibility score that measures the likelihood of applicants being approved. Selecting acceptance scores the likelihood of a card being accepted at most stores and being able to pay with your phone.

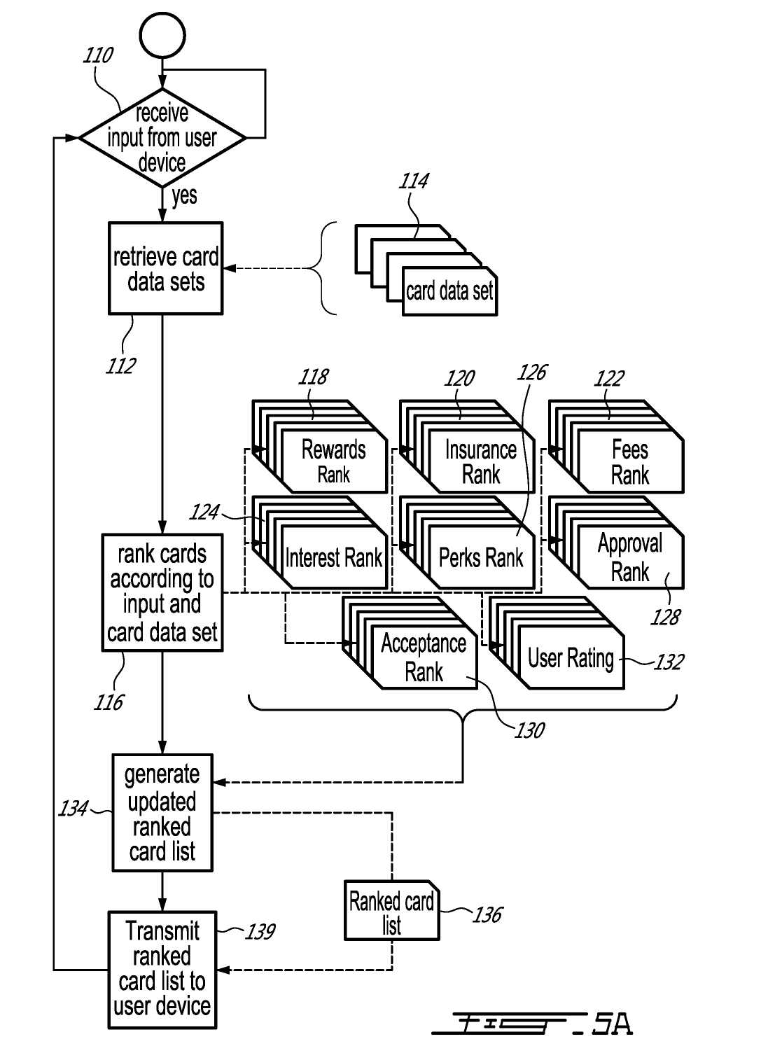

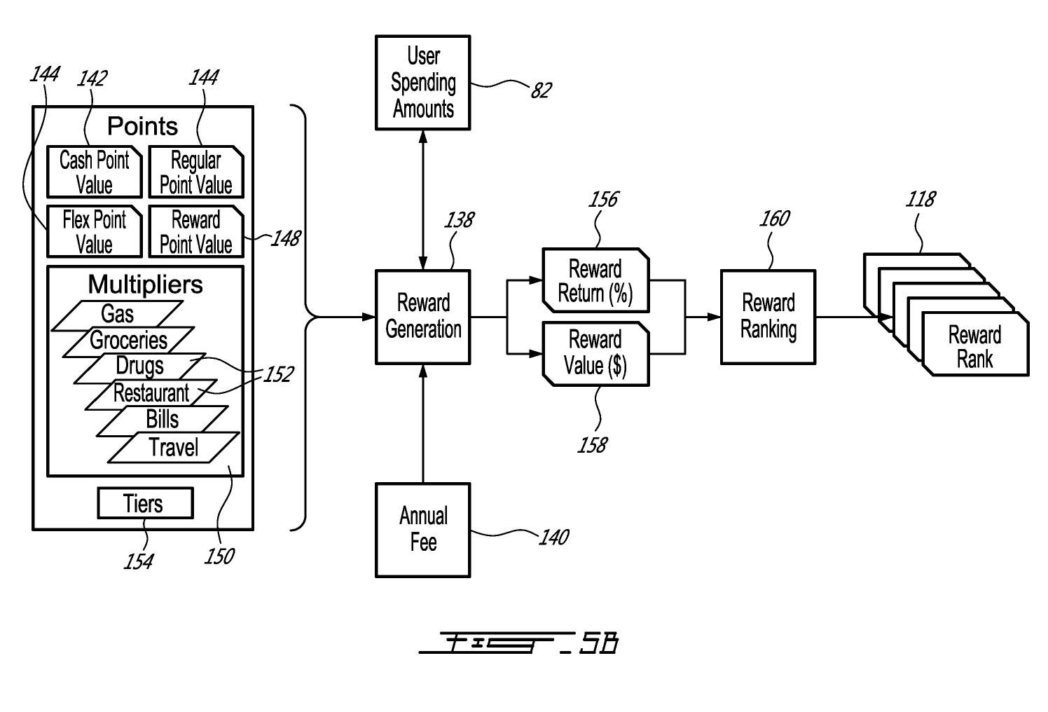

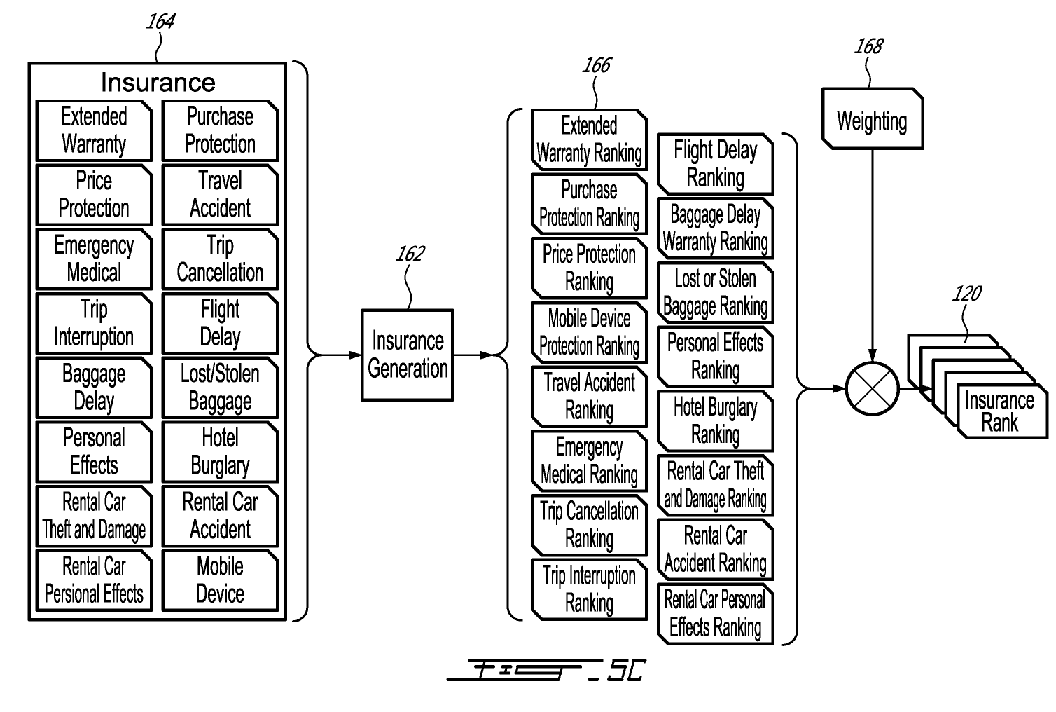

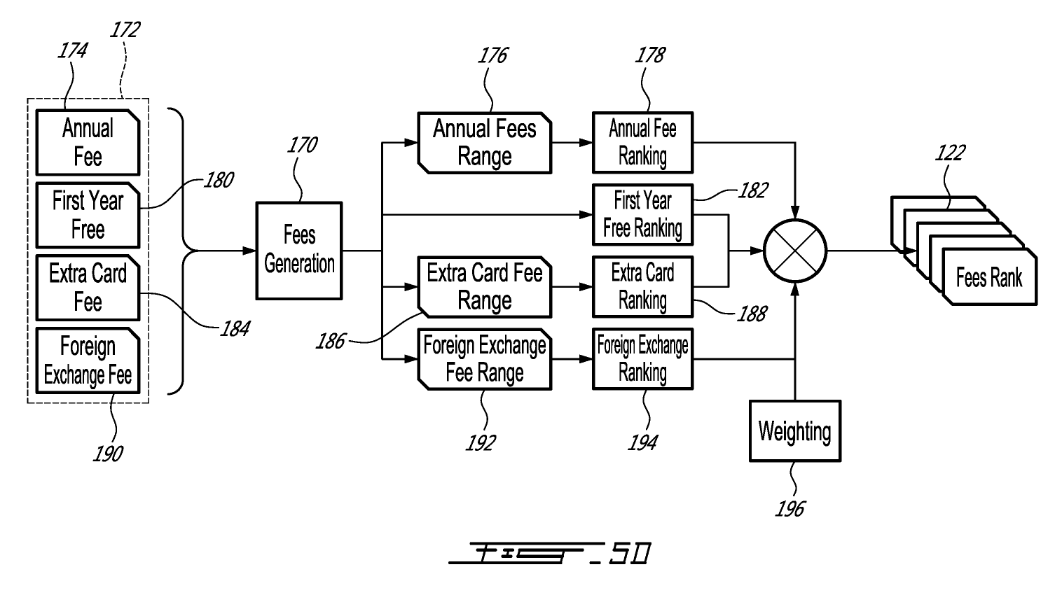

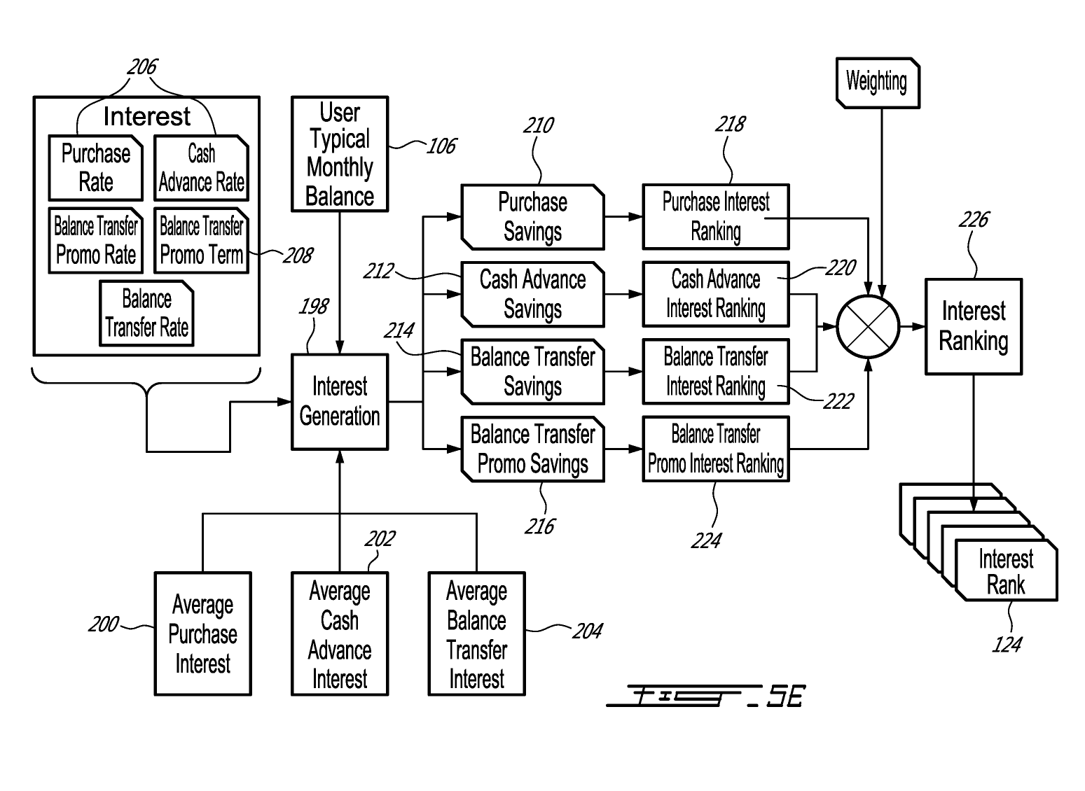

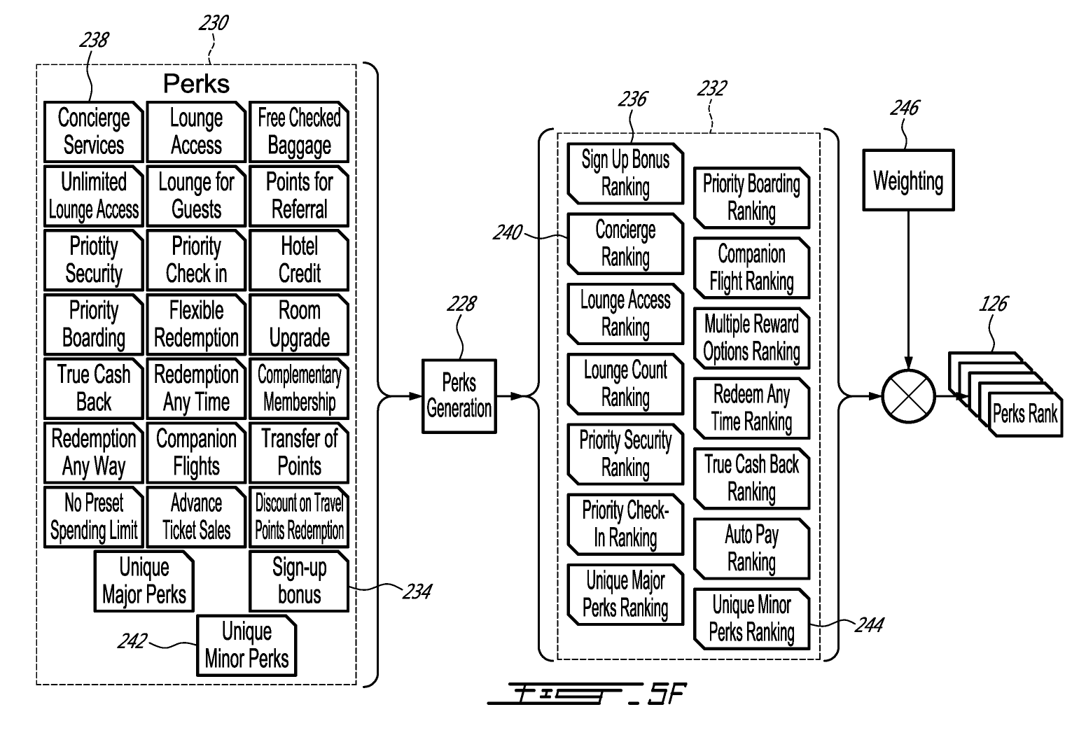

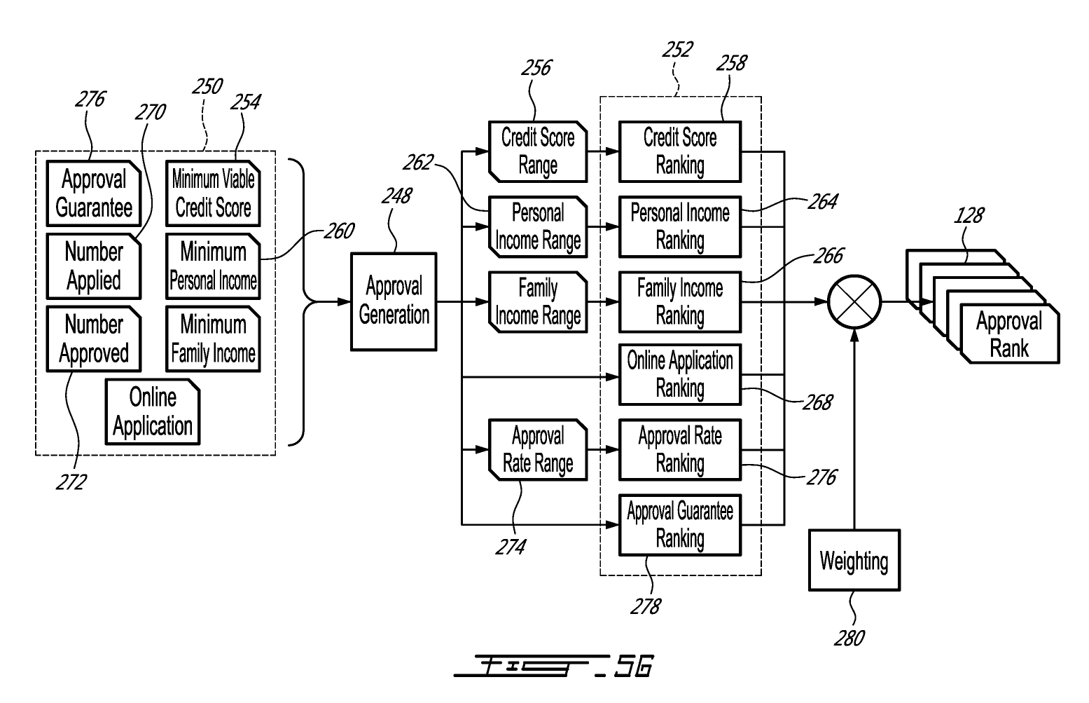

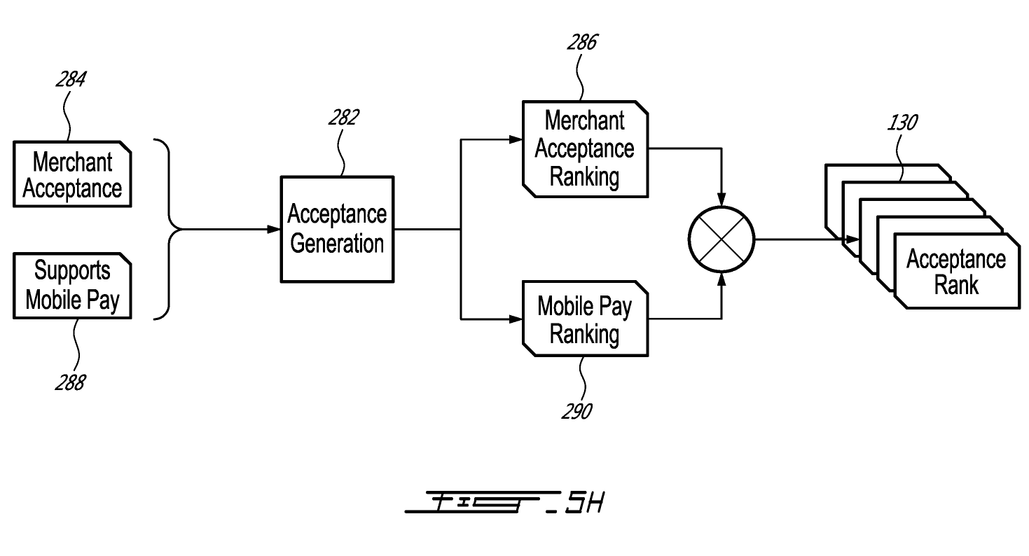

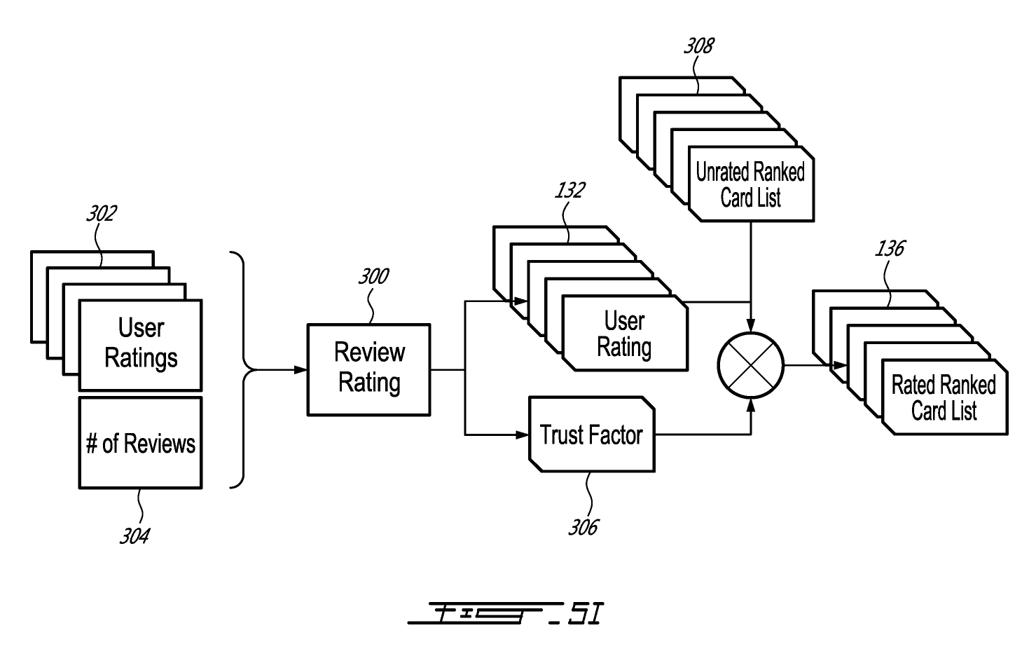

Referring now to FIG. 5A in addition to FIGS. 1 and 2, as discussed above the rating system 12 receives input from user devices 110, retrieves 112 card data sets 114 from the database 24, weights 116 the cards according to user input and the card datasets 114 to produce a reward rank 118, an insurance rank 120, a fees rank 122, an interest rank 124, a perks rank 126, an approval rank 128 and an acceptance rank 130, and if applicable a user rating 132, generates 134 an updated ranked card list 136 by combining the reward rank 118, the insurance rank 120, the fees rank 122, the interest rank 124, the perks rank 126, the approval rank 128, the acceptance rank 130 and the user rating 138 and transmits 139 the updated ranked card lists 134 to the user devices via the WAN 18. User inputs are relayed to the weighting engine 22 by the portal 26 which additionally can administer user accounts and the like. In an illustrative embodiment the card data sets are held within the database 24 but may also be held in main memory or the like (not shown). In a particular embodiment user ratings review rank 136 can be combined with the reward rank 118, the insurance rank 120, the 118 fees rank 122, the interest rank 124, the perks rank 126, the approval rank 128 and the acceptance rank 130 to provide an updated ranked card list 136 which additionally reflects users' subjective reviews of a given card. In the event that an insufficient number of reviews are available to provide a dependable user review rank, a default user rating rank, for example depending on the type of card or issuer, could be applied.

Referring now to FIG. 5B in addition to FIG. 5A and FIG. 2, in an illustrative embodiment the weighting engine 22 comprises a reward generation engine 138. The rewards rank 118 is determined by the reward generation engine 138 by evaluating various point values provided by each card data set in combination with user spending amounts 82 and the annual card fee 140. In this regard the point values of a given card comprise one or more of inter alia a cash point value 142, a regular point value 144, a flex point value 146 and a travel/reward point value 148 illustratively expressed as a point value per dollar spent. In some cases, and depending on the card in question, a point multiplier 150 may be used for a purchase in a particular category 152. Categories might include inter alia gas, groceries, drugs such as medications, restaurants, bills and travel. In particular cases a tier 154 may apply, for example a first multiplier for purchases under a first amount and a second multiplier for purchases in excess of the first amount. The reward generation engine 138 illustratively outputs a reward percentage 156 and a reward dollar value 158 which are ranked by the reward ranking engine 160.

Still referring to FIG. 5B, some cards allow rewards of one kind to be converted into rewards of another kind, typically at a predetermined rate of conversion. Additionally, cash provided by a card which rewards purchases with cash back may be used to purchase travel. Depending on user selections, one or other of the cash point value 142, the regular point value 144, the flex point value 146 and the travel/rewards point value 148 as well as the particular rates of conversion are used when determining the reward percentage 156 and the reward dollar value 158. As a result, cards offering cash back are illustratively ranked for a user who has a preference for travel rewards and cards which allow for some conversion of purchases into real dollars, for example investments, loan payments and bank deposits statements and the like, are illustratively ranked for a user who has a preference for cash back.

Referring now to FIG. 5C in addition to FIG. 5A and FIG. 2, in an illustrative embodiment the weighting engine 22 comprises an insurance generation engine 162. The insurance rank 120 is determined by the insurance generation engine 162 by evaluating the different insurance categories 164 which are provided with a given card. Insurance categories 164 may include inter alia extended warranty, price protection, purchase assurance, mobile device, satisfaction guarantee, baggage delay insurance, rental car collision damage insurance, rental car theft insurance, hotel burglary insurance, personal effects burglary insurance, lost luggage insurance, stolen luggage insurance, damaged luggage insurance, travel accident insurance and trip cancellation insurance. Output of the insurance generation engine 162 is an intermediate ranking 166 of each of the cards in respective ones of the insurance categories 164. Intermediate ranking is determined dependent to some degree on the type of insurance category 164 being ranked. For example, categories of insurance related to warranties or purchase protection are ranked according to their respective durations (e.g. 1 year extended protection, 60 days price protection). Other types of insurance, such as accident insurance for example, may be ranked according to the maximum amount of coverage, which in some cases is a dollar value and in other cases can be a duration, for example the number of days medical coverage in a hospital will be provided. In these cases, if available, a coverage range between a minimum coverage and a maximum coverage may be calculated and a given card ranked within this range. Also, other insurances, for example if the coverage is de facto unlimited, are ranked based solely on their availability. Of course, cards that provide no insurance in one or other of the categories are typically not ranked or ranked lowest. The intermediate rankings 166 are weighted according to their respective insurance weighting 168 to provide the final insurance rank 120 when combined. In this regard, each insurance weighting 168 is illustratively a percentage such that when combined with all other insurance weightings the total is 100%.

Referring now to FIG. 5D in addition to FIG. 5A and FIG. 2, in an illustrative embodiment the weighting engine 22 comprises a fees generation engine 170. The fees rank 122 is determined by the fees generation engine 170 which evaluates fee related features 172 such as annual fees, first year free, extra card fees and foreign exchange fees. Annual fees 174 are illustratively evaluated to determine an annual fee range 176, between a minimum dollar amount and a maximum dollar amount to be paid annually determined for all cards, or a particular subset of cards as the case may be, and the annual fee of a given card rated against the annual fee range 176 to determine the annual fee ranking 178. A minimum dollar amount typically $0. First year free 180 are ranked on whether this feature is present or not to determine the first year free ranking 182. Similar to annual fee 174, extra card fees 184 are illustratively evaluated to determine an extra card fee range 186, between a minimum dollar amount and a maximum dollar amount to be paid annually determined for all cards, or a particular subset of cards as the case may be. The extra card fee of a given card is evaluated against the extra card fee range 186 to determine its extra card fee ranking 188. Foreign exchange fees 190 are illustratively evaluated to determine the foreign exchange fee range 192 (in percentage points between a minimum and maximum) levied on foreign currency transactions. Of note is that most cards currently levy a 2.5% charge on all foreign currency transactions. The foreign exchange fee of a given card is evaluated against the foreign exchange fee range 192 to determine its foreign exchange ranking 194.

Still referring to FIG. 5D in addition to FIG. 5A, the annual fee ranking 178, the first year free ranking 182, the extra card ranking 188 and the foreign exchange ranking 194 are combined according to their respective fee weighting 196 to provide the final fees rank 122. In this regard, each fee weighting 196 is illustratively a percentage such that when combined with all other fee weightings the total is 100%.

Referring now to FIG. 5E in addition to FIG. 5A and FIG. 2, in an illustrative embodiment the weighting engine 22 comprises an interest generation engine 198. The interest rank 124 is determined by the interest generation engine 198 which evaluates the users typical monthly balance 106 together with the average purchase interest rate 200, cash advance interest rate 202 and average balance transfer interest rate 204 overall credit cards and the interest rates 206 which are levied by a particular card. Interest rates may include inter alia a purchase interest rate, a cash advance interest rate, a balance transfer rate and a balance transfer promotional rate. The term of a promotional balance transfer 208 may also be taken into account. The interest generation engine 198 outputs a dollar value savings which may be expected from each of the credit cards including a purchase savings 210, a cash advance savings 212, a balance transfer savings 214 and a balance transfer promotional savings 216. The purchase savings 210, the cash advance savings 212, the balance transfer savings 214 and the balance transfer promotional savings 216 are used respectively by a purchase interest ranking engine 218, a cash advance interest ranking engine 220, a balance transfer interest ranking engine 222 and a balance transfer promotional interest ranking engine 224 to rank each of the credit cards separately. The outputs of the purchase interest ranking engine 218, the cash advance interest ranking engine 220, the balance transfer interest ranking engine 222 and the balance transfer promotional interest ranking engine 224 are combined by the interest ranking engine 226 to provide the interest rank 124.

Referring now to FIG. 5F in addition to FIG. 5A and FIG. 2, in an illustrative embodiment the weighting engine 22 comprises a perks generation engine 228, The perks rank 126 is determined by the perks generation engine 228 which evaluates a plurality of different perk categories 230 offered to determine an intermediate perk category ranking 232 of each of the different perk categories. In some cases, perks can be evaluated against a range. For example, sign up bonus 234 is typically awarded as a number of points. As such, the perks generation engine 228 first determines a range for the sign up bonus 234 over all cards, or a selected subset of cards, and then evaluates a given card against this range to determine the intermediate sign up bonus ranking 236. Other perks, such as concierge service 238, can be ranked based solely on their availability to determine the concierge service rank 240. Still other perks, such as unique minor perks 242 can illustratively be evaluated according to the number of such perks offered to determine the unique minor perks rank 244.

Still referring to FIG. 5F in addition to FIG. 5A, the intermediate perk rankings 232 are combined according to their respective perk weightings 246 to provide the final perks rank 126. In this regard, each weighting 246 is illustratively a percentage such that when combined with all other perk weightings the total is 100%.

Referring now to FIG. 5G in addition to FIG. 5A and FIG. 2, in an illustrative embodiment the weighting engine 22 comprises an approval rank generation engine 248. The approval rank 128 is determined by the approval rank generation engine 248 which evaluates a plurality of different approval related features 250 to determine a plurality of different intermediate approval related rankings 252. Based on the minimum viable credit score 254 of all cards required for card approval, or a selected subset of cards, the approval rank generation engine 248 determines a credit score range 256. A credit score ranking 258 then determined for each card based on the cards required minimum viable credit score 254 and the credit score range 256. Similarly, a minimum personal income 260 of all cards required for card approval a minimum personal income range 262 is determined. The personal income ranking 264 is then determined for each card based on the cards minimum personal income 260 and the minimum personal income range 262. A similar approach is used to determine the family income ranking 266. The online application ranking 268 is determined based on the availability of online application. The approval rank generation engine 248 also evaluates the number of applications 270 for a given card versus the number of applications approved 272 for the card and determines an approval rate range 274. The average approval rate ranking 276 is then determined for each card based on the cards approval rate (determined from the number of applications 270 and the number of applications approved 272 for that card) and its rank within the approval rate range 274. Certain cards provide guaranteed approval for applicants of a particular quality, such as students or those willing to pay a security deposit or the like. This information forms part of the approval guarantee feature 276 which is used by the approval rank generation engine 248 to determine the approval guarantee ranking 278.

Still referring to FIG. 5G in addition to FIG. 5A, the credit score ranking 258, the personal income ranking 264, the family income ranking 266, the online application ranking 268, the approval rate ranking 276 and the approval guarantee ranking 278 are combined according to their respective approval weightings 280 to provide the final approval rank 128. In this regard, each weighting 280 is illustratively a percentage such that when combined with all other perk weightings the total is 100%.

Referring now to FIG. 5H in addition to FIG. 5A and FIG. 2, in an illustrative embodiment the weighting engine 22 comprises an acceptance rank generation engine 284. The acceptance rank 130 is determined by the acceptance rank generation engine 282 which evaluates merchant acceptance 284 of all cards to determine a merchant acceptance ranking 286 and whether or not the cards support mobile pay 288 to determine a mobile pay ranking 290. Merchant acceptance 284 is illustratively based on the type of card with Mastercard for example having a high acceptance and American Express having for example a low acceptance. The merchant acceptance ranking 286 and the mobile pay ranking 290 are combined to determine the acceptance rank 130.

Referring back to FIG. 4, logged in users can enter a rating between 1 and 5 stars for a given card. Cards that have been rated include a rating bar 292 comprising a number of (illustratively 5) stars 294. The total number of ratings 296 is also provided. By rolling over the rating bar 292 a breakdown 298 of the user ratings can be viewed.

Referring now to FIGS. 5I in addition to FIG. 5A and FIG. 2, in an illustrative embodiment the weighting engine comprises a user review rating engine 300. The user rating 132 is determined by the review rating engine 300 which evaluates user ratings 302 for a given credit card. The number of reviews 304 of a given card is also evaluated to determine a trust factor 306 for each card. In one embodiment user ratings 302 are entered by a plurality of users as a number of points, for example a number of stars or the like, relative to a user's perception of how the good the card is overall. Typically, a lower number of points is awarded to card perceived as relatively bad and more points to a card perceived as relatively good.

Still referring now to FIGS. 5I in addition to FIG. 5A, the user rating 132 is determined based on an average user rating. The user rating 132 and the trust factor 306 are illustratively applied to an unrated ranked card list 308 (i.e. the ranking of all cards according to user input and card data sets 114 but absent user ratings 302). In one embodiment the user ratings 302 comprise a value between 1 and 5, with 1 being considered a low rating and 5 a high rating. In the event a resultant user rating 132 for a given card is 5, for example, then the ranking of the given card will be increased in the rated ranked card list 136, illustratively by 10%. On the other hand, if the resultant user rating 132 for a given card is 1, for example, then the ranking of the given card will be decreased in the rated ranked card list 136, illustratively by 10%. Similarly, a user rating 132 of 4 and 2, for example, give rise respectively to a smaller increase and smaller decrease in the ranking of the card in the rated ranked card list 136, illustratively both 5%. A user rating 132 of 3 would illustratively have no effect on the ranking of the card in the rated ranked card list 136. Intermediate user rating 132 values, such as 2.3 or 4.5, have the same relative effect of increasing or decreasing the ranking of the given card between 0 and 10%.

Still referring now to FIG. 5I in addition to FIG. 5A, the effect of the user rating 132 on the overall card ranking is tempered by the trust factor 306. Illustratively the trust factor 306 for a given card is a multiplier of between 0 and 1 which is determined based on the number of reviews 304 for that given card. For example, if less than a minimum, illustratively five (5), reviews are available the reviews are considered untrustworthy and the trust factor 306 is 0. If more than the minimum number of reviews (illustratively 5) are available, then the trust factor is illustratively set to the number of reviews 304 divided by 100. Illustratively an upper limit of 100 reviews is required to be considered 100% trustworthy and as such, when more than 100 reviews are present the trust factor is set to 1.

Although the present invention has been described hereinabove by way of specific embodiments thereof, it can be modified, without departing from the spirit and nature of the subject invention as defined in the appended claims.

1. A computer system for executing a real-time online rating of a plurality of credit cards, the system comprising:
a communication network interconnecting an online rating system with at least one user device;
said at least one user device comprising a display and at least one user device processor and operatively associated user device electronic storage, wherein said user device storage comprises user device instructions that, when executed by said at least one user device processor, cause said at least one user device:
to provide a user interface via said display, said user interface comprising:
a first input comprising a plurality of sliders, each of said sliders corresponding to a respective pair of benefits and comprising a slider thumb slideable between at least a first position and a second position and a third position in between said first position and said second position, wherein said first position is associated with the user's preference for a first one of said respective pair of benefits, said second position is associated with the user's preference for a second one of said respective pair of said benefits and said third position is associated with a user preference for neither of said respective pair of benefits;
a second input corresponding to a typical monthly spending amount of the user; and
a ranked list of credit cards;
receive from the user, via said user interface, as input data said first and second inputs;
transmit said input data to said rating system via said communication network;
receive from said rating system via said communication network said ranked list of credit cards in response to providing said input data;
said online rating system comprising:
a database storing a plurality of card data sets, each of said card data sets corresponding to a respective one of the plurality of credit cards, each of said card data sets comprising a plurality of associated rewards and each of a plurality of associated features; and
a weighting engine comprising at least one weighting processor and operatively associated weighting electronic storage, wherein said weighting storage comprises benefit weighting coefficients and weighting instructions that, when executed by said at least one weighting processor, cause said weighting engine to, in response to reception of said input data from said at least one user device, retrieve a plurality of said card data sets from said database, calculate a plurality of different benefit ranks using said plurality of associated rewards and said plurality of associated features for each of said card data sets wherein at least one of said different benefit ranks is calculated using additionally said second input, and combine said calculated benefit ranks according to said benefit weighting coefficients and according to said first input data to generate a set of ranked credit cards, and transmit said set of ranked credit cards to said user device as said ranked list of credit cards.

2. The system of claim 1, wherein one of said plurality of sliders is for selecting between a pair of benefits comprising cash and travel+.

3. The system of claim 1, wherein one of said plurality of sliders is for selecting between a pair of benefits comprising low fees and insurance.

4. The system of claim 1, wherein one of said plurality of sliders is for selecting between a pair of benefits comprising low interest and perks.

5. The system of claim 1, wherein one of said plurality of sliders is for selecting between a pair of benefits comprising ease of approval and ease of acceptance.

6. The system of claim 1, wherein said first input comprises three of said sliders, wherein a first of said sliders corresponds to a first pair of benefits consisting of cash back and travel and rewards, wherein a second of said sliders corresponds to a second pair of benefits consisting of no fees and maximum return and a third of said sliders corresponds to a third pair of benefits consisting of low interest and perks.

7. The system of claim 1, wherein said first input comprises four of said sliders, wherein a first of said sliders corresponds to a first pair of benefits consisting of cash back and travel plus, wherein a second of said sliders corresponds to a second pair of benefits consisting of low fees and insurance, a third of said sliders corresponds to a third pair of benefits consisting of low interest and perks, and a fourth of said sliders corresponds to a fourth pair of benefits consisting of ease of approval and ease of acceptance.

8. The system of claim 1, wherein said rewards comprise one of cash back, pseudo cash, airline miles, travel points and points.

9. The system of claim 1, wherein said features comprise one of minimum credit score, minimum personal income, perks, insurance, interest rates, fees, approval related features and acceptance related features.

10. The system of claim 1, wherein said second input comprises a plurality of spending inputs.

11. The system of claim 1, wherein said plurality of spending inputs comprises a default annual spend, a regular spend percentage, a gas spend percentage, a grocery spend percentage, a drugstore spend percentage, a bills spend percentage, a travel spend percentage and combinations thereof.

12. The system of claim 1, wherein said rank is between 0 and 5.

13. The system of claim 1, wherein said input data is transmitted automatically in response to movement to any user input including a new position of one of said slider thumbs and resulting in an update of said rank.

14. The system of claim 1, wherein said user interface further comprises a third input corresponding to a maximum annual fee amount the user is willing to pay, wherein said third input is received from the user via said user interface, wherein said input data received from said user further comprises said third input and wherein a subset of said ranked credit cards are selected in accordance with said third input and wherein said subset of ranked credit cards are transmitted to said user device as said ranked list of credit cards.

15. The system of claim 1, wherein said user interface further comprises a fourth input corresponding to a personal annual income of the user, wherein said fourth input is received from the user via said user interface, wherein said input data received from said user further comprises said fourth input and wherein a subset of said ranked credit cards are selected in accordance with said fourth input and wherein said subset of ranked credit cards are transmitted to said user device as said ranked list of credit cards.

16. The system of claim 1, wherein said user interface further comprises at least one of a fifth input comprising at least one filter, said at least one filter narrowing said ranked list of cards, wherein said input data received from said user further comprises at least one of said fifth input and wherein said weighting engine further combines said weighting coefficients with at least one of said fifth input to generate said set of ranked cards.

17. The system of claim 1, wherein said weighting coefficients comprise a user rating weighting coefficient, said user rating weighting coefficient calculated from rating points entered by a plurality of users.

18. A method for executing a real-time online rating of a plurality of credit cards for a user, the method comprising:
interconnecting using a communication network an online rating system with a user device associated with the user, said user device comprising a display screen;
displaying on said display screen:
a first input comprising a plurality of sliders, each of said sliders corresponding to a respective pair of benefits and comprising a slider thumb slideable between at least a first position and a second position and a third position in between said first position and said second position, wherein said first position is associated with the user's preference for a first one of said respective pair of benefits, said second position is associated with the user's preference for a second one of said respective pair of said benefits and said third position is associated with a user preference for neither of said respective pair of benefits;
a second input corresponding to a typical monthly spending amount of the user; and
a ranked list of credit cards;
said user device:
receiving from the user, via said user interface, as input data said first and second inputs;
transmitting said input data to said online rating system via said communication network;
receiving from said online rating system via said communication network said ranked list of credit cards in response to providing said input data; and
displaying said ranked list of credit cards on said display screen as said ranked list of credit cards;
in response to reception of said input data from said user device, said online rating system:
retrieving a plurality of card data sets from a database, each of said card data sets corresponding to a respective one of the plurality of credit cards, each of said card data sets comprising a plurality of associated rewards and a plurality of associated features;
calculating a plurality of different benefit ranks using said plurality of associated rewards and said plurality of associated features for each of said card data sets wherein at least one of said different benefit ranks is calculated using additionally said second input;
combining said calculated benefit ranks according to at least one benefit weighting coefficient and said first input data to generate a set of ranked credit cards, and
transmitting said set of ranked credit cards to said user device as said ranked list of credit cards.

19. The method of claim 18, wherein one of said weighting coefficients is a user rating weighting coefficient and further wherein said online rating system calculates said user rating weighting coefficient from rating points entered by a plurality of users.
